(19) United States
(12) Patent Application Publication
(10) Pub. No.: US 2010/0020714 A1
(43) Pub. Date: Jan. 28, 2010

(54) MOBILE RADIO COMMUNICATIONS DEVICE MEASUREMENT

(75) Inventors: Christophe Rosik, Tokyo (JP); Marianne Lampure, Tokyo (JP)

Correspondence Address: YOUNG & THOMPSON, 209 Madison Street, Suite 500, Alexandria, VA, 22314, US

(73) Assignee: NEC CORPORATION, TOKYO (JP)

(21) Appl. No.: 12/525,692

(22) PCT Filed: Feb. 1, 2008
(86) PCT No.: PCT/JP2008/052078

§ 371 Date: Aug. 4, 2009

(30) Foreign Application Priority Data
Feb. 6, 2007 (GB) 0702251

(51) Int. Cl. H04L 12/26

(52) U.S. Cl. 370/252

(57) ABSTRACT

The present invention provides for a method of facilitating mobile radio communications device measurements within a mobile radio communications network, including the step of including within a Resource Block sent to the mobile radio communications device from the network an indication of the number of subsequent consecutive Transmission Timing Intervals with no allocated Resource Blocks and so as to provide to the mobile radio communications device a signal serving to indicate the time period available for device measurements.

The present invention relates to measurement required of a mobile radio communications device when operating within a mobile radio communications network and, in particular, to a device, network device, and related method of facilitating such measurements.

In mobile radio communications networks, such as evolved Universal Terrestrial Radio Access eUTRA network, the eNodeB is arranged to control the allocation and de-allocation of resources to the Long Term Evolution (LTE) User Equipment (UE) terminals. Such resources are generally scheduled by taking into account the Quality of Service (QoS) requirements associated with the radio bearers and also with regard to the channel quality information for each UE.

The data traffic arising in relation to the provision of such resources need not necessarily be continuous. For example, even with high bit-rates, the data traffic can be adapted by the eNodeB in order to create gaps therein. For lower bit-rates, the data traffic is in any case characterised by the inclusion of gaps therein.

Thus, while independent of the actual bit-rate, gaps within the data traffic can arise or be created, current network and UE arrangements nevertheless exhibit limitations and disadvantages insofar as the scheduling of UE measurements is disadvantageously restricted and the possibilities for scheduling measurements at the UEs is disadvantageously limited.

The present invention therefore seeks to provide for a mobile radio communications device, a network device, and related method of facilitating inter-RAT or inter-frequency measurements within a mobile radio communications device, and to related network signalling, which exhibit advantages over known such devices, methods and signalling.

According to a first aspect of the present invention there is provided a method of facilitating mobile radio communications device measurements within a mobile radio communications network, including the step of including within a Resource Block sent to the mobile radio communications device an indication of the number of subsequent consecutive TTIs with no allocated Resource Blocks.

The invention proves advantageous insofar as the mobile radio communications device can then employ the gaps arising or created in the data traffic to schedule its inter-RAT or inter-frequency measurements as appropriate. Through the provision of the above-mentioned indication, it readily becomes possible for the mobile radio communications device to determine the duration of such “non-data” periods well in advance and thereby readily determine whether or not the period of consecutive Transmission Timing Intervals (TTIs) without allocated Resource Blocks is sufficient for the required measurement.

Preferably, the said indications are included within the last Resource Block (PRB) of a series of such blocks.

Further, the aforesaid measurement can advantageously comprise a measurement requiring more than one TTI.

Yet further, the method can include the step of optimising the network data flow so as to create the said subsequent consecutive TTIs without allocated PRBs.

According to one particular feature, the aforementioned indication can be included in a field within downlink scheduling information.

As such, the field can provide an indication of the next successive TTIs that can be scheduled and, alternatively, the maximum number of consecutive TTIs that can be scheduled.

It will of course be appreciated that each TTI can comprise a subframe.

The method can include the step of facilitating inter-RAT or inter-frequency measurements in a mobile radio communications device arranged to receive signalling from an eNodeB.

In this manner, the method can provide for the said indication within Long Term Evolution (LTE) network cells.

According to another aspect of the present invention, there is provided a mobile radio communications device arranged for operation within a mobile radio communications network and for performing measurements therein, the device being arranged to receive a Resource Block (PRB) including an indication of the number of subsequent consecutive TTIs having no allocated PRBs, and to schedule said measurements accordingly.

As before, the mobile radio communications device can be arranged to receive said indication when included within the last of a series of PRBs.

Also, the said measurement to be conducted by the mobile radio communications device can be one requiring more than one TTI.

Yet further, the mobile radio communications device can be arranged to receive the said indication when included in a field within downlink scheduling information.

As before, the field can be arranged to provide an indication of the next successive TTIs with no allocated resource blocks that can be scheduled, or alternatively, the maximum number of consecutive TTIs with no resource blocks that can be scheduled.

Further, each TTI comprises a subframe and the mobile radio communications device can be arranged to receive the said indication from an eNodeB.

The mobile radio communications device also can be arranged to receive said indication, and conduct its inter-RAT or inter-frequency measurements, within LTE network cells.

To take in account the possible Hybrid-ARQ retransmission, the mobile radio communications device can start its measurements T0 after the reception of the latest received PRB in order. T0 would be fixed in UE and estimated to the Hybrid-ARQ round trip time.

With regard to yet a further aspect of the present invention, there is provided a mobile radio communications network device for delivering Resource Blocks to a mobile radio communications device within the network, the network device being arranged to include within a Resource Block an indication of subsequent consecutive TTIs without allocated Resource Blocks.

As suggested above, the network device can be arranged to provide the said indication within the last PRB of a series of such blocks.

Further, the network device can be arranged to modify the data flow within the network so as to provide for the said subsequent TTIs with no data.

Yet further, the network device can be arranged to provide the said indication in a field within downlink scheduling information.

Such an element can advantageously be arranged to provide an indication of the next successive TTIs with no resource blocks allocated that can be scheduled, or alternatively, the maximum number of consecutive TTIs with no data that can be scheduled.

Again, each TTI can comprise a subframe and, in one particular embodiment, the mobile radio communications network device can comprise an eNodeB.

In such a manner, the network device can be arranged to operate within an LTE network cell.

According to still a further aspect of the present invention, there is provided a mobile radio communications network signal for facilitating measurements at a mobile radio communications device within a mobile radio communications network, the signal including a Resource Block having an indication of the number of subsequent consecutive TTIs without allocated Resource Blocks.

Advantageously, the signal is arranged such that the said indication is included within the last of a series of PRBs.

The signal is advantageously arranged to facilitate an inter-RAT or inter-frequency measurement requiring more than one TTI.

Advantageously, the network signalling comprises downlink scheduling information and, can further include a specific field. The specific field is advantageously arranged to indicate the next successive TTIs with no allocated resource blocks that can be scheduled or alternatively, the maximum number of consecutive TTIs that can be scheduled. In one particular embodiment, the signal can be arranged such that each TTI comprises a subframe.

Yet further, the signal can be provided by way of an eNodeB and can be provided for facilitating mobile radio communication device measurements within an LTE network cell.

As should be appreciated from the above, the concept of the present invention allows for the provision of information within a mobile radio communications device concerning radio resource scheduling in order to allow the device to accurately manage its inter-RAT or inter-frequency measurements during “no-data” periods.

Such accurate measurement and use of such periods, and the general resource scheduling, is not generally possible within the current state of the art.

The invention is described further hereinafter, by way of example only, with reference to the accompanying drawings in which:

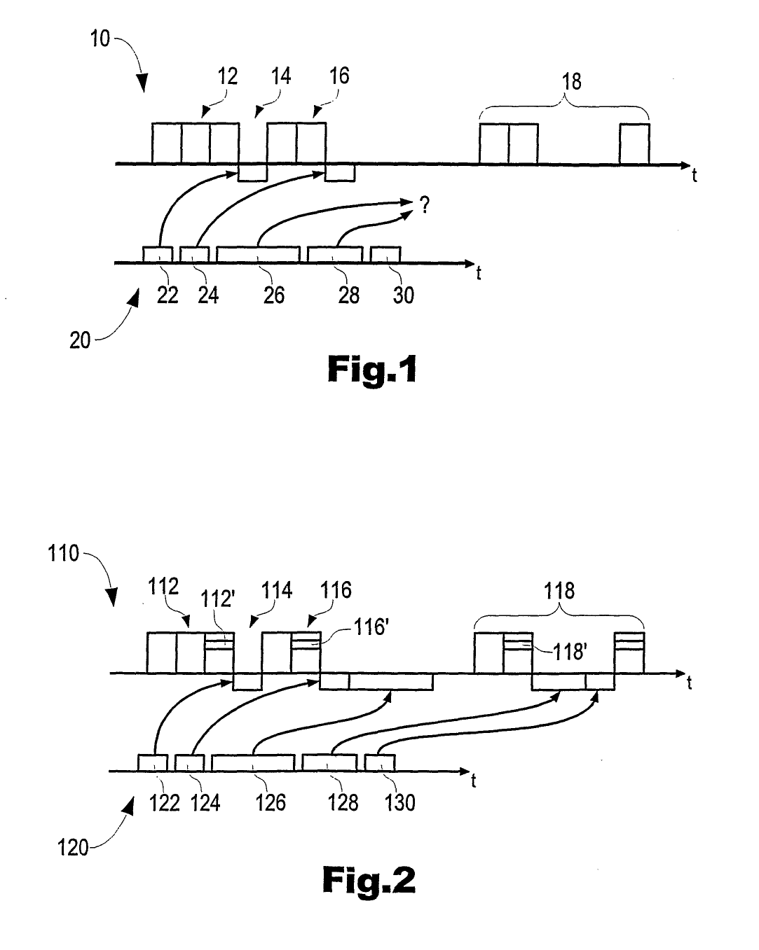

FIG. 1 is a timing diagram illustrating the limitation on scheduling arising in the current art;

FIG. 2 is a timing diagram illustrating the operation of one embodiment of the present invention and serving to overcome limitations found in the current art; and

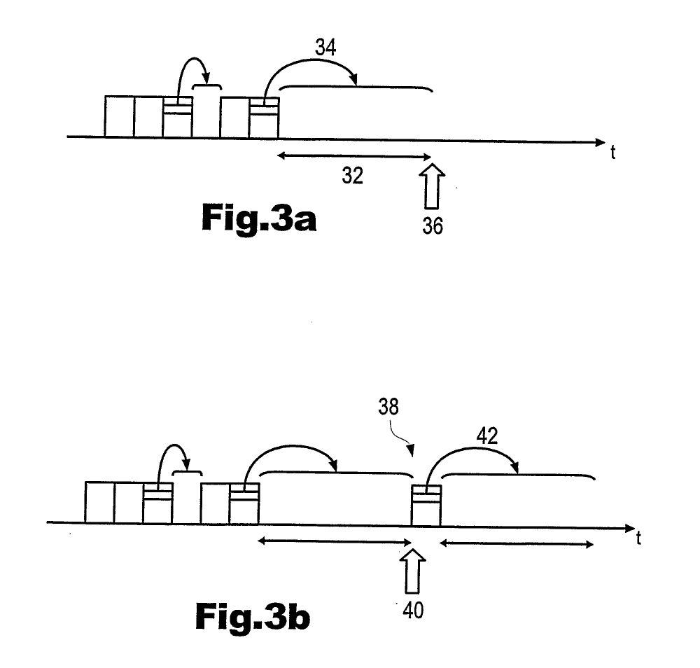

FIGS. 3A and 3B illustrate the operation of one particular embodiment of the present invention depending upon different indications provided within PRBs arising within network signalling.

As will be appreciated, the broad concept of the present invention can be embodied within an arrangement in which the last PRB in a series of PRBs sent within an LTE cell by an enodeB, contains an field specifying the number of next consecutive TTIs in which there are no PRBs allocated to the mobile radio communications network.

Such information can advantageously be employed by the mobile radio communications device to plan and manage the use of the “no traffic” periods in order to perform its required measurements. As will be appreciated, the concept of the present invention is particularly useful for performance of measurements requiring more than one TTI such as, for example, inter Radio Access Technology (RAT) measurements.

For measurements requiring less than one TTI, the mobile radio communications device can perform these as soon as it is found that no resources are allocated to it within a single TTI.

While data traffic at low bit rates will inherently have periods with no data arising therein, high bit rate traffic can be adapted at the eNodeB such that gaps are introduced by the eNodeB as required.

Although the measurement duration for LTE cells might be considered as not yet defined, the example of UTRA cells provides timing along the lines of the following:
Step 1 duration (for slot synchronisation) should be approximately in the order of 30 ms
Step 2 duration (for frame synchronisation and scrambling code group detection)+Step 3 duration (for scrambling code detection) should be approximately in the order of 20 ms
Cell level measurement duration should be approximately in the order of 2 ms

Furthermore, the time to switch the RF from LTE to UTRAN, and then after UTRA measurements, from UTRAN to LTE, should approximately be in the order of 0.4 ms.

So if an LTE mobile radio communications device terminal needs to perform one measurement on one UTRA cell, the terminal will require 30+20+2=52 ms every 5 seconds (generally required that the MS shall report a new best UTRAN cell at the least 5 seconds after it has been activated).

Even if such measurements can be performed in “burst” mode in several gaps, the minimum gap duration required is that defined by the cell level measurement, which is 2 ms, and in addition to the 0.4 ms of for the RF switch, which in total equates to three LTE TTIs.

This shows that in most case, the mobile radio communications device will require more than one TTI to perform a UTRA Cell level measurement, and so the concept of the present invention serving to inform the device on how many consecutive subframes have no PRB can be advantageously employed.

The basic characteristics of the concept of the present invention are readily illustrated through a comparison of FIGS. 1 and 2.

In FIG. 1, there is illustrated a timing diagram 10 according to the current state of the art and showing the delivery of a series of PRBs 12, 16, 18 from an eNodeB to a mobile radio communications device.

As will be appreciated, the PRBs are shown as an initial series of three PRBs 12 separated from a pair of PRBs 16 by a “no traffic” period 14, and then followed by a group 18 comprising a pair of PRBs and a single PRB.

The timing diagram also shows a series of planned measurements 20 which are required at the mobile radio communications device: the measurements being in series as two single measurements requiring one subframe 22, 24, followed by a three sub-frame measurement 26 and then followed by a two subframe measurement 28 and finally a single subframe measurement 30.

As will be appreciated, a mobile radio communications device can perform its required measurements only when it sees that no PRB is allocated to it and so, to prevent interruption of such measurements, only single subframe measurements are possible since the mobile radio communications device cannot identify whether or not the “no single period” 14 might last for more than one subframe.

On this basis, only planned measurements 22, 24 can be executed as indicated, the subsequent measurements 26, 28, each requiring more than a single subframe, cannot be performed even though, subsequent to the pair of PRBs 16, there is sufficient “no signal period” within which the three subframe planned measurement 26 could in fact be performed.

Turning therefore to FIG. 2, there is illustrated a similar timing diagram but in accordance with an embodiment of the present invention.

Again, a timing line 110 is illustrated for a series of PRBs 112, 116, 118 and with the PRBs 112 and 116 again being separated by a single subframe period 114.

Also, as with FIG. 1, a series of planned measurements are indicated which again comprise two single subframe measurements 122, 124, a three subframe measurement 126, a two-subframe measurement 128 and a further single subframe measurement 130.

Importantly with regard to the embodiment as illustrated in FIG. 2, each of the final PRBs in the respective series of PRBs 112, 116, 118 illustrated, includes an indication, comprising a field 112′ 116′ and 118′, which serves to confirm the number of subsequent consecutive subframes from which no data arises.

That is, field 112′ indicates that the subsequent “no data” period 114 comprises a single subframe, whereas field 116′ indicates that the subsequent “no data” period comprises a five subframe period.

On this basis, the planned measurement 122 can, as with FIG. 1, again be conducted in the initial single subframe period 114, and, in view of the signalling 116 comprising the field 116′, the mobile radio communications device knows that there is sufficient time before the next series of PRBs 118 arises, for execution of the planned measurements 124 and 126: totalling four subframes. Yet further, the field 118′ serves to indicate that there is sufficient subsequent period for the completion of the planned subframe measurement 128 and the single subframe measurement 130.

Thus, unlike the scenario illustrated with regard to FIG. 1, the embodiment of the present invention as illustrated in FIG. 2 allows for the mobile radio communications device to quickly and efficiently, complete all of its required measurements within the same data period as arising in relation to FIG. 1.

As noted previously, this information can be included in the downlink scheduling information, for example as part of resource assignment.

To confirm the above operation, if the field 112′, 116′ or 118′ is not present, PRBs are assumed allocated in the next subframe and measurements cannot be planned or the eNodeB cannot provide prediction for such measurements.

Field is arranged to specify the number of next successive TTIs with no transmitted data (NTTI).

Preferably the maximum number of consecutive TTIs that the eNB is able to schedule (NTTImax) can be defined according to eNB scheduler capabilities, QoS requirements and channel quality information. Further the value can be dynamically modified if required.

As a further consideration, Nlim an be defined so that NTTImax never exceed Nlim, in order to guarantee a degree of flexibility in scheduler algorithm and to prevent eventual exceptions. If however UE detects that NTTI exceeds Nlim, it considers that the value is erroneous and can determine that its measurements should not be performed. Nlim could be estimated to run the same duration to that of the max gaps length defined in (TGLI, TGL2) for UTRAN i.e. fourteen slots/ten TTI of 1 ms length (refer to 25.922 & 25.133), and according also to scheduler capabilities.

On this basis, NTTI can be set to {1, . . . , NTTImax, . . . , Nlim}.

However, FIG. 3a illustrates that, if the eNB scheduler cannot foresee the next allocated PRB after NTTImax (32), it sets NTTI to NTTImax (34). In such a scenario, the mobile radio communications device stops its measurements at subframe ‘NTTImax+1’ (36) and checks for allocated PRBs. Such a manner of operation is illustrated in FIG. 3a.

Next, FIG. 3b illustrates a scenario wherein, if the eNodeB scheduler is still not able to predict the next allocation of resources at subframe NTTImax (38), it can decide to send an indication at subframe NTTImax+1 (40) to the mobile radio communications device by allocating a PRB with the information, described in the innovation, set to NTTImax (42).

As will therefore be appreciated, the present invention finds particular use with regard to LTE related products, such as eNodeBs and the related UEs and so has the potential for advantageous use within 3GPP standards

1. A method of facilitating mobile radio communications device measurements within a mobile radio communications network, including the step of including in a Resource Block sent to the mobile radio communications device from a network an indication of the number of subsequent consecutive Transmission Timing Intervals with no allocated Resource Blocks.

2. A method as claimed in claim 1, wherein the said indications are included within the last Resource Block of a series of such blocks.

3. A method as claimed in claim 1 or 2, wherein the said measurement is performed on one of another frequency or another Radio Access Technology, so as to halt communication.

4. A method as claimed in claim 1, 2 or 3, wherein the said measurement can advantageously comprise a measurement requiring more than one Transmission Timing Interval.

5. A method as claimed in claim 1, 2, 3 or 4, and including the step of optimising the network data flow so as to create the said subsequent consecutive Transmission Timing Intervals without allocated Resource Blocks.

6. A method as claimed in any one or more of claims 1 to 5, wherein the said indication is included in a field within downlink scheduling information.

7. A method as claimed in claim 6, wherein the field provides an indication of the next successive Transmission Timing Intervals that can be scheduled for measurements.

8. A method as claimed in claim 7, wherein the field provides the maximum number of consecutive Transmission Timing Intervals that can be scheduled for measurements, if the eNodeB is not able to foresee allocated resource blocks.

9. A method as claimed in any one or more of claims 1 to 8 and including the step of facilitating inter frequency and inter Radio Access Technologies (RAT) measurements in a mobile radio communications device arranged to receive signalling from an eNodeB.

10. A mobile radio communications device arranged for operation within a mobile radio communications network and for performing measurements therein, the device being arranged to receive a Resource Block including an indication of the number of subsequent consecutive Transmission Timing Intervals having no allocated Resource Blocks, and to schedule said measurements accordingly.

11. A device as claimed in claim 10, and arranged to receive said indication when included within the last of a series of Resource Blocks.

12. A device as claimed in claim 10 or 11, wherein the said measurement to be conducted by the mobile radio communications device can be one requiring more than one Transmission Timing Interval.

13. A device as claimed in claim 10 or 11, wherein the said measurement to be conducted by the mobile radio communications device can start T0 following the reception of the latest PRB to take in account the possible Hybrid-ARQ retransmission.

14. A device as claimed in claim 10, 11 or 12 and arranged to receive the said indication when included in a field within downlink scheduling information.

15. A device as claimed in claim 10, 11, 12 or 14, wherein each Transmission Timing Interval comprises a subframe and the device is further arranged to receive the said indication from an eNodeB.

16. A mobile radio communications network device for delivering Resource Blocks to a mobile radio communications device within the network, the network device being arranged to include within a Resource Block an indication of subsequent consecutive Transmission Timing Intervals without allocated Resource Blocks.

17. A network device as claimed in claim 16 and arranged to provide the said indication within the last Resource Block of a series of such blocks.

18. A network device as claimed in claim 16 or 17 and arranged to optimise the data flow within the network so as to provide for the said subsequent Transmission Timing Intervals.

19. A network device as claimed in claim 16, 17 or 18, and arranged to provide the said indication in a field within downlink scheduling information.

20. A network device as claimed in claim 19, wherein the field provides an indication of the next successive Transmission Timing Intervals that can be scheduled for measurements.

21. A network device as claimed in claim 20, wherein the field provides an indication of the maximum number of consecutive Transmission Timing Intervals that can be scheduled for measurements, if the eNodeB is not able to foresee allocated resource blocks.

22. A mobile radio communications network signal for facilitating measurements at a mobile radio communications device within a mobile radio communications network, the signal including a Resource Block having an indication of the number of subsequent consecutive Transmission Timing Intervals without allocated Resource Blocks.

23. A signal as claimed in claim 22 and arranged such that the said indication is included within the last of a series of Resource Blocks.

24. A signal as claimed in claim 22 or 23, and arranged to facilitate a measurement requiring more than one Transmission Timing Interval.

25. A signal as claimed in any one or more of claims 22 to 24, and provided in a field within downlink scheduling information.

26. A signal as claimed in claim 25 wherein the field is arranged to indicate the next successive Transmission Timing Intervals that can be scheduled for measurements.

27. A signal as claimed in claim 26, wherein the field is arranged to indicate the maximum number of consecutive Transmission Timing Intervals that can be scheduled for measurements.

28. A signal as claimed in any one or more of claims 22 to 27 in which the said Transmission Timing Interval comprises a subframe.

29. A method facilitating mobile radio communication device measurements within a mobile radio communications network and substantially as hereinbefore described with the reference to, and as illustrated in, FIGS. 2 and 3 of the accompanying drawings.

30. A mobile radio communications device arranged for operating within a mobile radio communications network and substantially as hereinbefore described with reference to FIGS. 2 and 3 of the accompanying drawings.

31. A mobile radio communications network device substantially as hereinbefore described with reference to FIGS. 2 and 3 of the accompanying drawings.

32. A mobile radio communications network signal substantially as hereinbefore described with reference to FIGS. 2 and 3 of the accompanying drawings.
